(19) United States
(12) Patent Application Publication
(10) Pub. No.: US 2013/0016108 A1
(43) Pub. Date: Jan. 17, 2013

(54) INFORMATION PROCESSING APPARATUS, INFORMATION PROCESSING METHOD, AND PROGRAM

(71) Applicant: Masaaki Isozu, Tokyo (JP)

(72) Inventor: Masaaki Isozu, Tokyo (JP)

(73) Assignee: SONY CORPORATION, Tokyo (JP)

(21) Appl. No.: 13/539,635

(22) Filed: Jul. 2, 2012

(30) Foreign Application Priority Data
Jul. 11, 2011 (JP) 2011-152487

(51) Int. Cl. G06T 1/00

(52) U.S. Cl. 345/501

(57) ABSTRACT

An information processing apparatus includes: a communication unit to receive, from another information processing apparatus, image data in an imaginary region having a first area, first tree information indicating a tree structure of the image data, and layout information indicating a layout of the image data; a cache memory to cache at least a part of the received image data; a display including a display region having a second area smaller than the first area, and to display a part of the cached image data in the display region; and a controller to divide the imaginary region into regions based on the second area and the received layout information, generate second tree information indicating a tree structure of the image data in accordance with the regions, and control the cache memory to cache the at least a part of the image data based on the second tree information.

### CROSS-REFERENCE TO RELATED APPLICATION

The present application claims priority from Japanese Patent Application No. JP 2011-152487 filed in the Japanese Patent Office on Jul. 11, 2011, the entire content of which is incorporated herein by reference.

### BACKGROUND

The present disclosure relates to an information processing apparatus including a cache memory, and an information processing method and program for the information processing apparatus.

In recent years, a client terminal has executed an application by a web browser via a network, and the types of client terminals have been increased. Along with the circumstances, it is general to hold, in a server, contents to be displayed on a screen of a client terminal after separating the contents into constituent element data (model) and display method data (view). For example, the server divides a web page into an HTML (HyperText Markup Language) and a CSS (Cascading Style Sheets) to transmit them to a client terminal for display. Accordingly, a loading time in the client terminal is shortened, and processing efficiency is improved, thus improving an apparent speed for executing display processing.

On the other hand, as another technique of speeding up display processing by a browser, necessary data may be cached in advance on a client side. For example, Japanese Patent Application Laid-open No. 2010-160441 (hereinafter, referred to as Patent Document 1) discloses an information processing apparatus that foresees data while detecting inputs by a user, such as operations of selection, return, scroll, and the like, to thereby easily perform a screen transition.

### SUMMARY

However, the technique disclosed in Patent Document above premises a previously fixed layout of data to be displayed. Therefore, the technique described above is difficult to be achieved in the case where data including contents to be displayed on a screen, which are divided into model and view, is handled as in the case described above.

In view of the circumstances as described above, it is desirable to provided an information processing apparatus, an information processing method, and a program that are capable of efficiently caching display data constituted of model and view.

According to an embodiment of the present disclosure, there is provided an information processing apparatus including a communication unit, a cache memory, a display, and a controller. The communication unit is configured to receive, from another information processing apparatus, a plurality of image data items that are laid out in an imaginary region having a first area, first tree information indicating a tree structure of the plurality of image data items, and layout information indicating a layout of the plurality of image data items. The cache memory is configured to cache at least a part of the received plurality of image data items. The display includes a display region having a second area that is smaller than the first area, and is configured to display a part of the cached plurality of image data items in the display region. The controller is configured to divide the imaginary region into a plurality of regions based on the second area and the received layout information. Further, the controller is configured to generate second tree information indicating a tree structure of the plurality of image data items in accordance with the plurality of regions. Furthermore, the controller is configured to control the cache memory to cache the at least a part of the plurality of image data items based on the second tree information.

Accordingly, the information processing apparatus efficiently caches display data constituted of model (a plurality of image data items or first tree information) and view (layout information) by generating second tree information for cache.

The controller may control the cache memory to impart points to the plurality of regions, cache in the cache memory an image data item laid out in a region to which points of a predetermined value or more are imparted, and delete from the cache memory an image data item laid out in a region to which points less than the predetermined value are imparted.

Accordingly, the information processing apparatus imparts points to the plurality of regions, to thereby cache an image data item having a high possibility of being displayed next and delete from the cache memory an image data item in a region having a low possibility of being displayed.

In a case where one of the plurality of image data items that is displayed in the display region is changed, the controller may regenerate the second tree information based on the changed image data item and recalculate the points to be imparted to the plurality of regions.

Accordingly, each time an image data item in the display region is changed, the information processing apparatus may change an image data item to be cached or deleted from the cache memory, to thereby maintain an optimum cache state. Here, the image data item may also be changed by, for example, a position of the information processing apparatus and outputs of various sensors of the information processing apparatus, in addition to a screen transition made by a scroll operation of a user.

The controller may calculate the points to be imparted to the plurality of regions such that the points become higher as a distance between, out of the plurality of regions, a region in which one of the plurality of image data items that is being displayed in the display region is laid out and another region becomes shorter.

Accordingly, the information processing apparatus caches an image data item that is close to a region of the image data item currently being displayed, and deletes from the cache memory an image data item farther from the image data item currently being displayed.

The controller may impart extra points, in addition to points corresponding to the distance, to the region in which one of the plurality of image data items that is being displayed in the display region is laid out.

Accordingly, the information processing apparatus reliably caches the image data item currently being displayed.

According to another embodiment of the present disclosure, there is provided an information processing method including receiving, from another information processing apparatus, a plurality of image data items that are laid out in an imaginary region having a first area, first tree information indicating a tree structure of the plurality of image data items, and layout information indicating a layout of the plurality of image data items. A part of the received plurality of image data items is displayed on a display including a display region having a second area that is smaller than the first area. The imaginary region is divided into a plurality of regions based on the second area and the received layout information. Second tree information indicating a tree structure of the plurality of image data items is generated in accordance with the plurality of regions. At least a part of the plurality of image data items is cached based on the second tree information.

According to another embodiment of the present disclosure, there is provided a program causing an information processing apparatus to executes the steps of: receiving, from another information processing apparatus, a plurality of image data items that are laid out in an imaginary region having a first area, first tree information indicating a tree structure of the plurality of image data items, and layout information indicating a layout of the plurality of image data items; displaying a part of the received plurality of image data items on a display including a display region having a second area that is smaller than the first area; dividing the imaginary region into a plurality of regions, based on the second area and the received layout information, and generating second tree information indicating a tree structure of the plurality of image data items; and caching at least a part of the plurality of image data items, based on the second tree information.

As described above, according to the present disclosure, it is possible to efficiently cache display data constituted of model and view.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a diagram showing a configuration of an image display system according to an embodiment of the present disclosure;

FIG. 2 is a diagram showing a hardware configuration of a user terminal in the image display system;

FIG. 3 is a functional block diagram showing software of the user terminal;

FIG. 4 is a diagram showing an example of tree information received by the user terminal from a server;

FIG. 5 is a diagram showing an example of view drawn based on the tree information of FIG. 4;

FIG. 6 is a diagram showing an example of layout information received by the user terminal from the server;

FIG. 7 is a diagram showing another example of the layout information received by the user terminal from the server;

FIG. 8 is a flowchart showing a procedure of cache processing by the user terminal;

FIG. 9 is a diagram showing an example of imaginary tree information generated by the user terminal;

FIG. 10 is a diagram showing an example of a screen drawn based on the imaginary tree information of FIG. 9;

FIG. 11 is a flowchart showing a procedure of processing of generating the imaginary tree information by the user terminal;

FIG. 12 is a flowchart showing a procedure of processing of setting points for each region and managing a cache by the user terminal;

FIG. 13 is a diagram showing an example in which points are set for each region; and

FIG. 14 is a diagram showing an example of metadata in a cache memory related to point setting processing.

### DETAILED DESCRIPTION OF EMBODIMENTS

Hereinafter, an embodiment of the present disclosure will be described with reference to the drawings.

### [Outline of System]

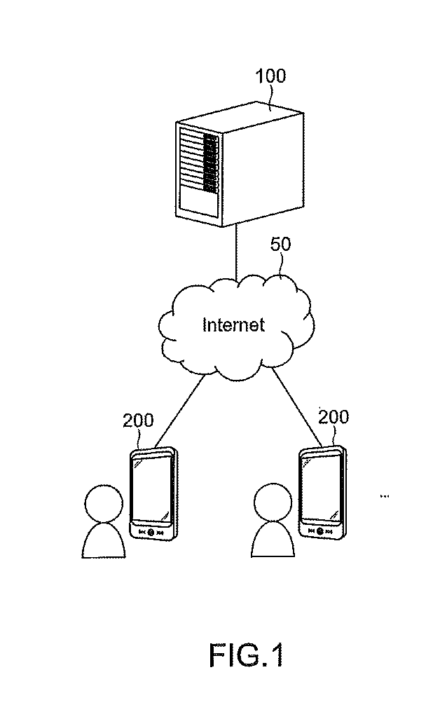

FIG. 1 is a diagram showing a configuration of an image display system according to an embodiment of the present disclosure.

As shown in FIG. 1, this system is constituted of a server 100 and a user terminal 200. The server 100 and the user terminal 200 communicate with each other through a network such as the Internet 50.

A plurality of user terminals 200 may exist in the image display system. The user terminals 200 are typically mobile terminals such as a smartphone, a mobile phone, and a tablet PC (Personal Computer), but may be any information processing apparatuses including desktop and laptop PCs, an electronic book reader, portable A/V (Audio/Visual) equipment, and the like.

The user terminal 200 downloads a large amount of images from the server 100 and displays the images by using a user interface. In this embodiment, in particular, an architecture of an user interface in which model and view are separated from each other is a target. In the user interface in which model and view are separated from each other, the server 100 manages model information, and the user terminal 200 on a client side changes view in accordance with an attribute of the device, an input from a user, and the like. Accordingly, a flexible system compatible with various types of user terminals 200 is achieved. Here, the model information refers to information stored in a database for page data and image data, and view information is assumed to be a tree structure for drawing, layout information, a design template, and the like. In a much broader sense, the tree structure may also be considered as the model information.

The user terminal 200 requests the server 100 to transmit a web page including a plurality of image files via a user interface of a web browser (hereinafter, referred to simply as browser). In response to the request, the server 100 transmits a web page and image files to the user terminal 200, together with tree information (for example, DOM (Document Object Model) tree) indicating a tree structure of the image files and layout information of the image files.

### [Hardware Configuration of User Terminal]

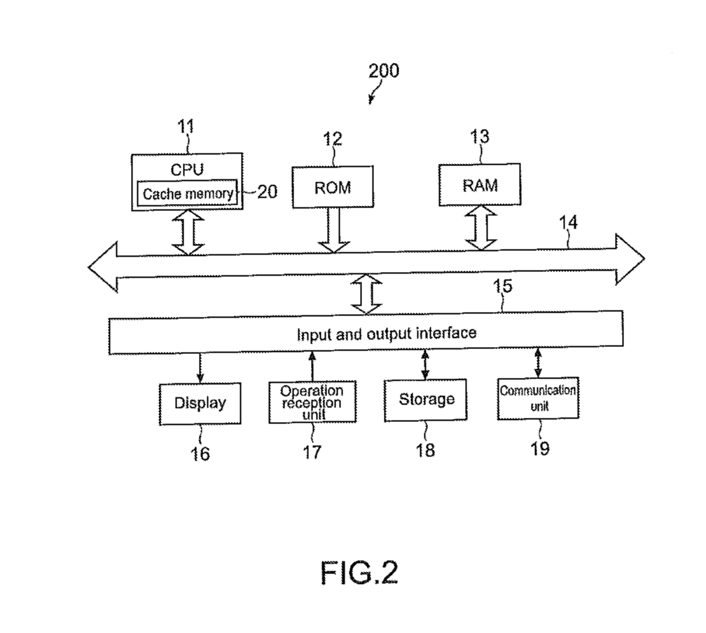

FIG. 2 is a diagram showing a hardware configuration of the user terminal 200. As shown in FIG. 2, the user terminal 200 includes a CPU (Central Processing Unit) 11, a ROM (Read Only Memory) 12, a RAM (Random Access Memory) 13, an input and output interface 15, and a bus 14 that connects those above components to one another.

The CPU 11 accesses the RAM 13 and the like when necessary and performs overall control on the respective blocks of the user terminal 200 while performing various types of computation processing. The ROM 12 is a non-volatile memory in which an OS to be executed by the CPU 11 and firmware such as programs and various parameters are fixedly stored. For example, the RAM 13 is a DRAM (Dynamic RAM) and is used as a main memory of the user terminal 200. The RAM 13 is used as a work region of the CPU 11 and temporarily stores the OS, various applications in execution, and various types of data being processed.

Further, a cache memory 20 is provided inside the CPU 11. The cache memory 20 caches image data received from the server 100. The cache memory 20 is an SRAM (Static RAM), for example, but any memory device may be used as the cache memory 20 as long as it is used as a primary storage capable of high-speed read and write. In the cache memory 20, data is held with a key and a value being paired with each other.

Connected to the input and output interface 15 are a display 16, an operation reception unit 17, a storage 18, a communication unit 19, and the like.

The display 16 is a display device using, for example, an LCD (Liquid Crystal Display), an GELD (Organic Electroluminescent Display), or a CRT (Cathode Ray Tube) and displays the image data received from the server 100.

The operation reception unit 17 is an input device including a pointing device such as a mouse, a keyboard, a touch panel, and other input devices. In the case where the operation reception unit 17 is a touch panel, the touch panel may be formed integrally with the display 16.

The storage 18 is a non-volatile memory such as an HDD (Hard Disk Drive), a flash memory (SSD (Solid State Drive)), or other solid-state memory. The storage 18 stores the OS, various applications, and various types of data.

The communication unit 19 is a NIC (Network Interface Card) or the like for wired connection to the Internet 50 or a LAN (Local Region Network), and performs communication processing (transmission of a request and reception of a response) with the server 100.

### [Software Configuration of User Terminal]

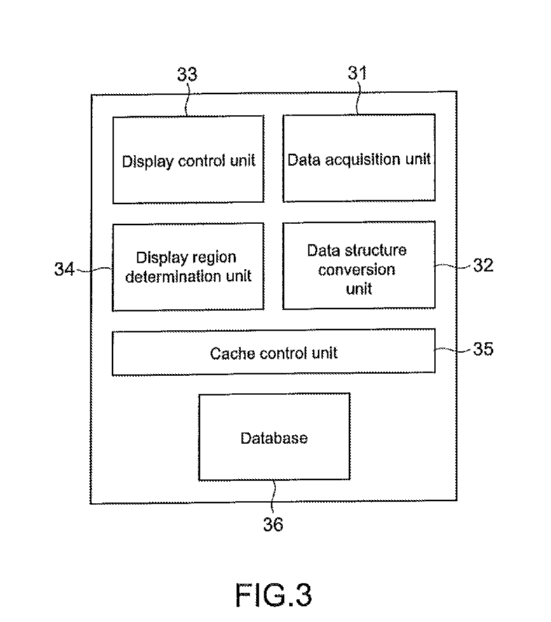

FIG. 3 is a functional block diagram showing software modules of the user terminal 200. The software modules are each provided as, for example, a function of an application for displaying in a list a large amount of image (picture) data arranged in chronological order. However, the software modules are not limited thereto.

As shown in FIG. 3, the user terminal 200 includes a data acquisition unit 31, a data structure conversion unit 32, a display control unit 33, a display region determination unit 34, a cache control unit 35, and a database 36.

The data acquisition unit 31 acquires image data, tree information (first tree information), and layout information from the server 100 via a network, and passes them to the data structure conversion unit 32.

The data structure conversion unit 32 converts the data acquired by the data acquisition unit 31 into a tree structure for cache of the cache memory 20 (second tree information), and stores it in the database 36.

The display control unit 33 displays the image data stored in the database 36 on the display 16 based on the layout information and changes display contents in accordance with an input from a user and a change of a context.

The display region determination unit 34 determines to which part of the data, within a layout region of the data received from the server 100, an image currently being displayed on the display 16 corresponds.

The cache control unit 35 executes an insertion of data into the cache memory 20 or a deletion of data from the cache memory 20 in accordance with the display contents determined by the display region determination unit 34.

### [Tree Information]

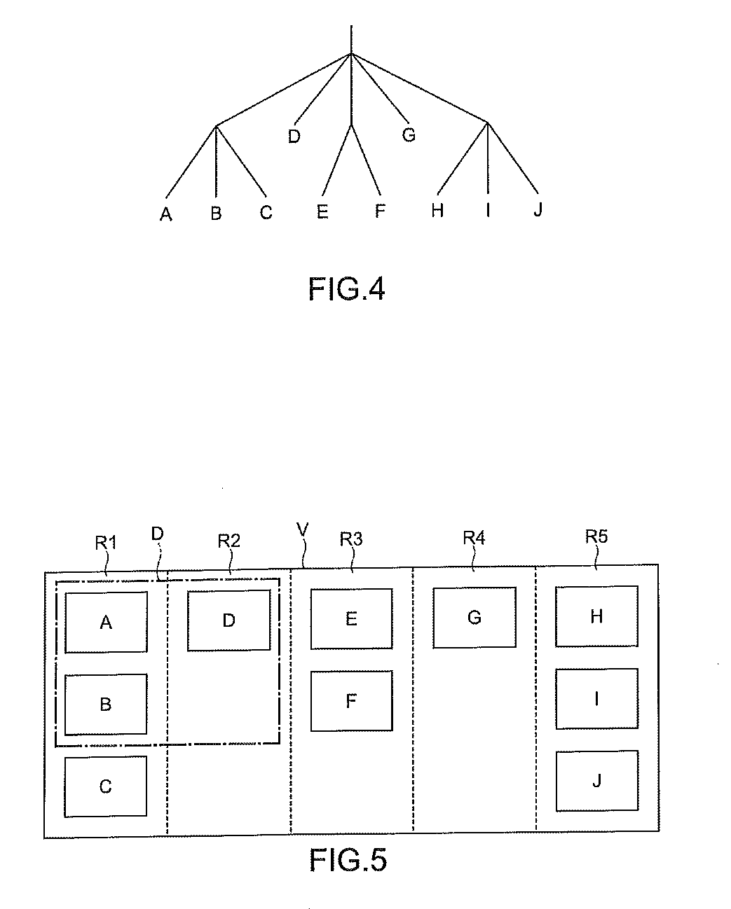

FIG. 4 is a diagram showing the tree information received from the server 100. Each of nodes (A to J) shown in FIG. 4 corresponds to an IMG (image) tag of one HTML (HyperText Markup Language), for example.

FIG. 5 is a diagram showing an example of view drawn based on the tree information described above.

In FIG. 5, an imaginary region V indicates a region in which image data indicated by the layout information is laid out. A screen display region D indicates a display region of the display 16. The screen display region D generally has an area smaller than that of the imaginary region V.

The imaginary region V is divided into five regions R1 to R5, for example. Image data items A to J are displayed in the regions R1 to R5 in accordance with the tree information described above. The regions are divided by, for example, an attribute of image data, such as a date and time of the creation thereof. The example of FIG. 5 shows a state in which only the image data items A, B, and D are displayed on the display 16.

As in this example, in the case where the tree information simply correspond to the screen display region D, the data to be held in the cache memory 20 is relatively easily predicted. In recent years, however, diverse display forms have been increasingly used in each terminal, and the tree structure does not correspond to the screen display region D in many cases. In this example, a system allowing a cache to be effectively used even in such a case is provided.

### [Layout Information]

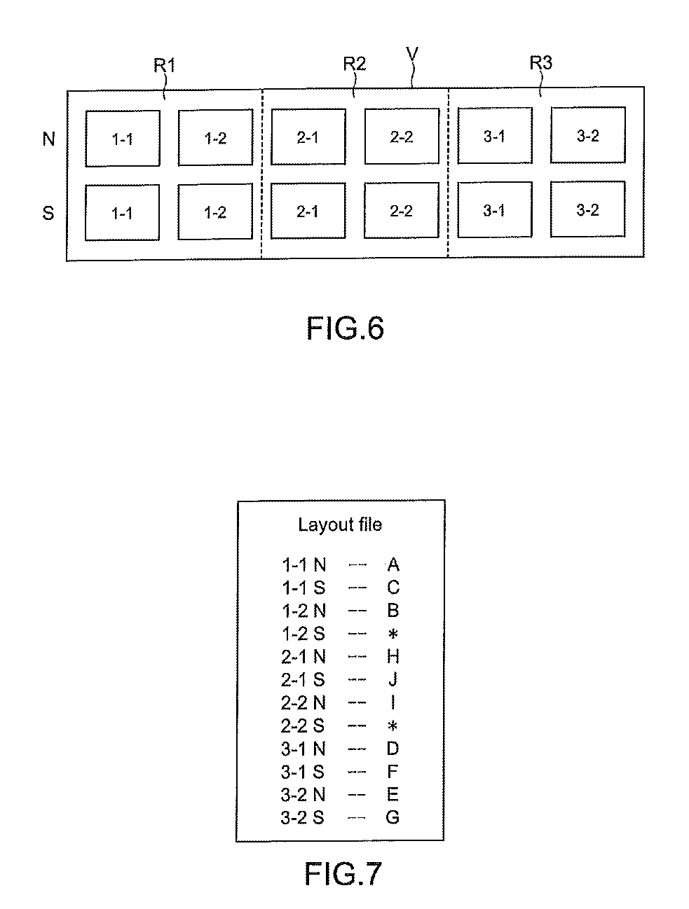

FIGS. 6 and 7 are diagrams each showing an example of the layout information received from the server 100.

FIG. 6 shows drawing position information and address information of image files on the display 16. In the example of FIG. 6, the imaginary region V is divided into three regions R1 to R3, and each region is provided with two positions, i.e., an upper portion (N) and a lower portion (S), at each of which image files are laid out (1-1, 1-2, . . . , 3-1, 3-2) (layout position).

FIG. 7 shows a file managed by the server 100 as a layout file. A name of an image file and address information for display (layout position described above) are stored in the layout file.

### [Operation of User Terminal]

Next, an operation of the user terminal 200 in the image display system configured as described above will be described. This operation will be performed in cooperation with other hardware and software (browser) under the control of the CPU 11 of the user terminal 200.

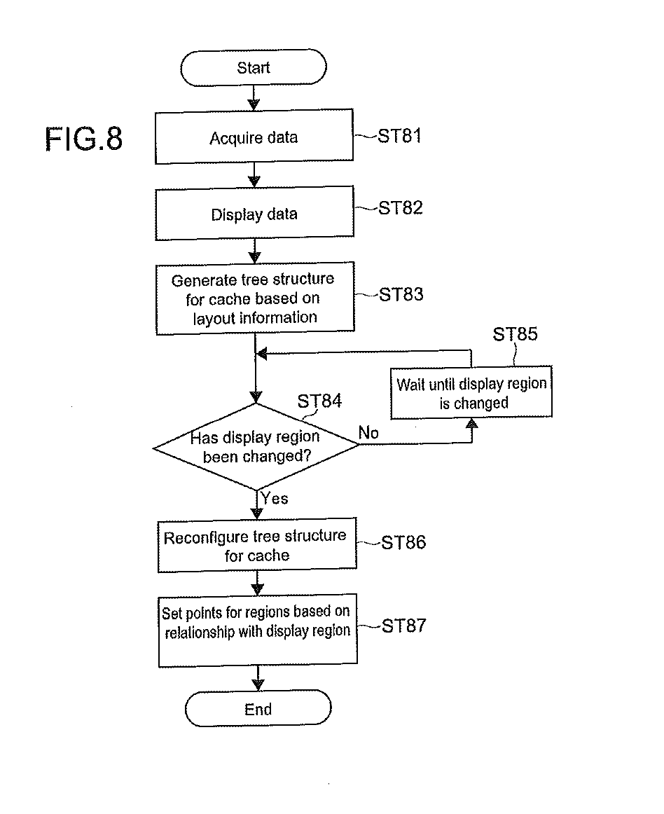

FIG. 8 is a flowchart showing a procedure of cache processing of image data by the user terminal 200.

As shown in FIG. 8, the CPU 11 first acquires image data, tree information (first tree information), and layout information from the server 100 (Step 81). The CPU 11 then displays the acquired image data on the display 16 based on the layout information (Step 82).

Subsequently, the CPU 11 generates imaginary tree information (second tree information) for cache based on the layout information, separately from the tree information (first tree information) received from the server 100 (Step 83).

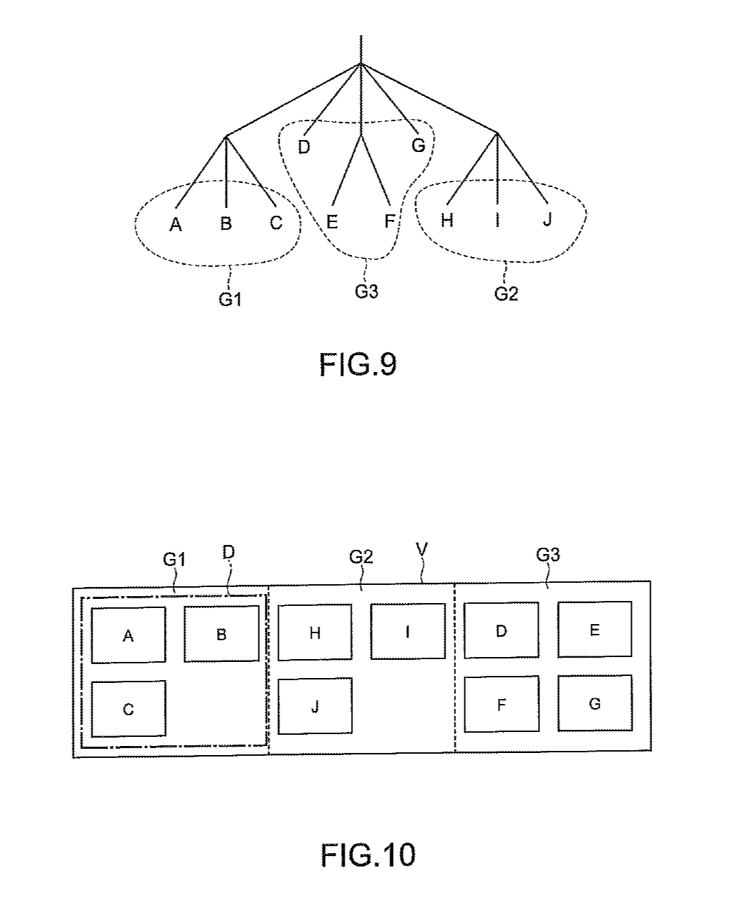

FIG. 9 is a diagram showing an example of the generated imaginary tree information. Further, FIG. 10 is a diagram showing an example of a screen drawn based on the imaginary tree information of FIG. 9.

As shown in FIG. 9, image files are divided into a plurality of groups (G1 to G3) in the above tree structure. One group corresponds to the screen display region D.

As shown in FIG. 10, the imaginary region V has an area three times as large as that of the screen display region D of the display 16. In FIG. 10, out of the groups corresponding to three screens, a group G1 on the left-hand side is a target to be displayed. In the tree information (see FIG. 4) received from the server 100, the image files D, E, F, and G are to be arranged next to the image files A, B, and C. In this case, however, the image files H, I, and J are laid out next thereto based on the layout information.

As described above, when the layout information becomes complicated, a case in which a logical tree structure and a screen display do not correspond to each other occurs with frequency.

Referring back to FIG. 8, the CPU 11 then determines whether the position of the display region for the image files in the imaginary region V has been changed (Step 84). In the case where the position has not been changed (No), the CPU 11 waits until any change is made (Step 85).

In the case where the position of the display region has been changed (Yes), the CPU 11 reconfigures the imaginary tree information for cache (Step 86).

Then, with the tree information being reconfigured, the CPU 11 sets points for each region based on a relationship with the current position of the display region (Step 87). The point setting processing performed on the regions will be described later.

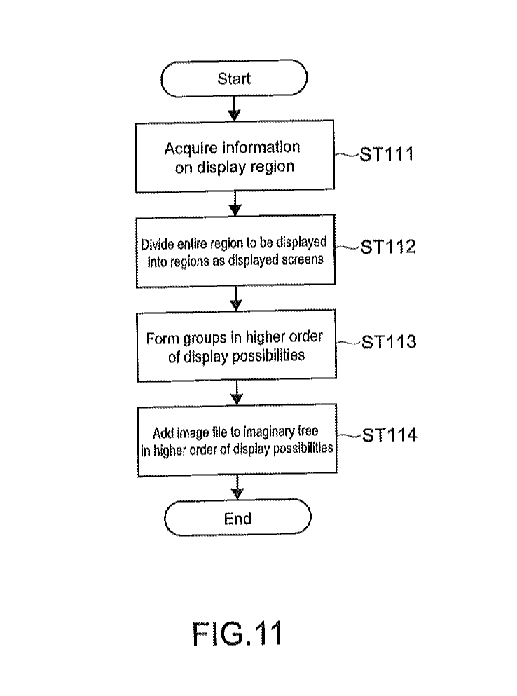

FIG. 11 is a flowchart showing details of processing of generating the imaginary tree information.

As shown in FIG. 11, the CPU 11 first acquires information on a display region (Step 111). The information on a display region refers to a size (area) and a resolution of the screen display region D of the display 16.

Subsequently, the CPU 11 divides the imaginary region V into regions each corresponding to the area of the screen display region D (Step 112). For example, in the example of FIGS. 9 and 10, the imaginary region V is divided into three regions (G1 to G3).

Subsequently, the CPU 11 divides (image files belonging to) the regions into groups in higher order of display possibilities (Step 113). In the example of FIGS. 9 and 10, the grouping is performed in accordance with a shorter distance from the current display region.

The CPU 11 then imparts a number corresponding to the order described above to each group and adds image files belonging to that group to an imaginary tree (Step 114). In place of the distance, for example, a preference degree (reproduction frequency) of a user about an image file, a date and time of creation of an image file, and the like are used for the grouping.

Although the tree is configured to be flat in the example of FIGS. 9 and 10, it may have a parent-child relationship in accordance with the display region. For example, in the case where the display region is changed by a zoom-in or zoom-out operation, image files before and after the zoom-in or zoom-out operation are considered as files having a parent-child relationship therebetween and are thus managed on the tree.

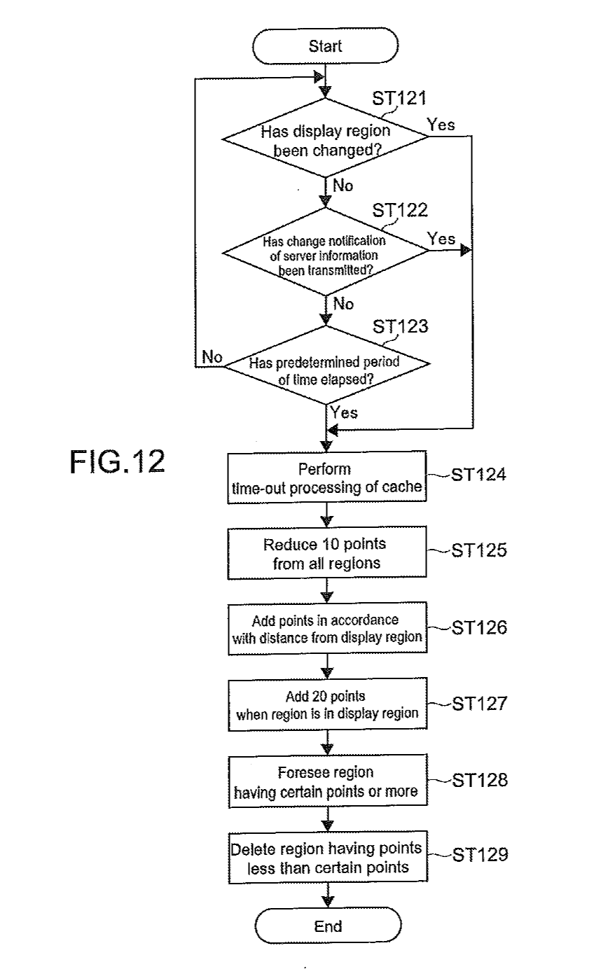

FIG. 12 is a flowchart showing a procedure of processing of setting points for each region and managing a cache by the user terminal 200.

As shown in FIG. 12, the CPU 11 first determines whether the display region within the imaginary region V has been changed by an operation of a user or the like (Step 121).

In the case where the display region has not been changed (No), the CPU 11 determines whether data change notification has been transmitted from the server 100 (Step 122).

In the case where data change notification has not been transmitted from the server 100 (No), the CPU 11 determines whether a predetermined period of time has elapsed after the cache of the image data (Step 123).

In the case where the CPU 11 determines “Yes” in Steps 121, 122, and 123, the CPU 11 executes time-out processing of the cache (Step 124). In other words, in the case where the cache memory 20 has an automatic deletion function based on an elapse time from the start of a cache, each time a predetermined period of time elapses, the CPU 11 deletes from the cache memory 20 data that has not been referred to within the predetermined period of time.

Subsequently, the CPU 11 reduces, for example, 10 points from the points imparted to each of the divided regions (Step 125).

Subsequently, the CPU 11 adds points to each region in accordance with a distance from the current display region (Step 126). In other words, for example, as a region is at a position closer to the current display region, a higher point is imparted thereto. Further, the CPU 11 adds, for example, 20 points exceptionally to the current display region (Step 127).

For example, a position to which a region moves by one screen transition (for example, one flick operation) is set to a distance 1, and points are imparted to the region in accordance with the distance, e.g., 20 points are imparted thereto in the case of the distance 1, and 10 points in the case of a distance 2.

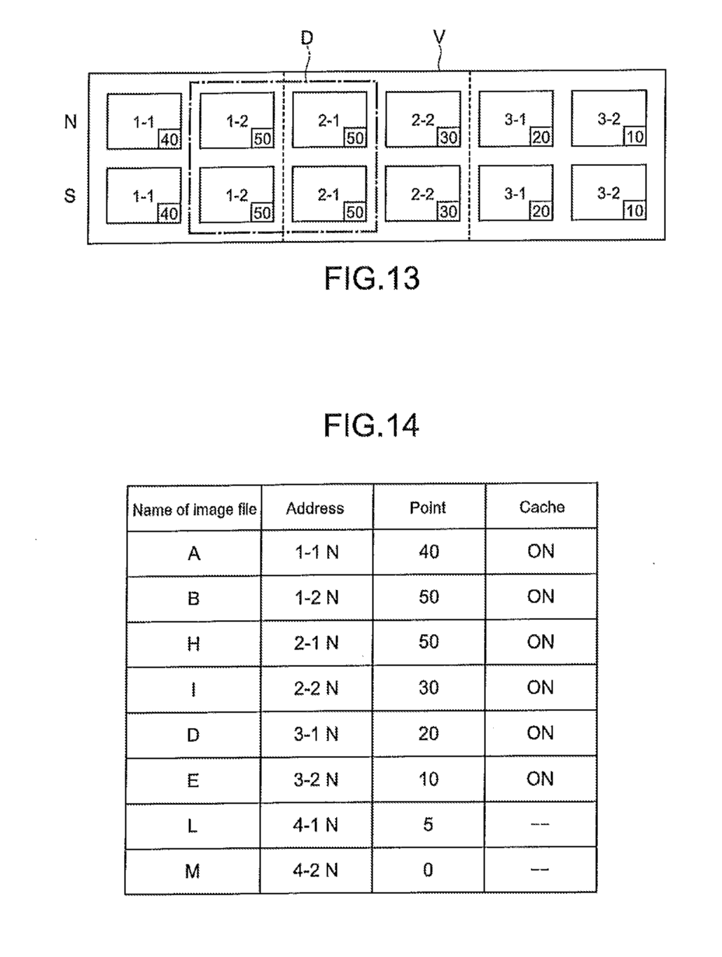

FIG. 13 is a diagram showing an example in which points are set for each region. As shown in FIG. 13, 50 points are imparted to the current display region D, and as a distance from the current display region D becomes longer, points are gradually reduced.

Referring back to FIG. 12, the CPU 11 foresees image data that belongs to a region having certain points or more and stores the image data in the cache memory 20 (Step 128). On the other hand, if image data that belongs to a region having points less than the certain points is stored in the cache memory 20, the CPU 11 deletes that image data (Step 129). For example, the certain points are set to 10 points, though not limited thereto.

Accordingly, image data of a region to be set to the next display region is always stored in the cache memory 20.

The cache memory 20 holds metadata on the point setting processing. FIG. 14 is a diagram showing an example of the metadata. As shown in FIG. 14, it is found that image files L and M each having points less than 10 points are deleted from the cache memory 20.

### [Conclusion]

As described above, according to this embodiment, the user terminal 200 generates imaginary tree information for cache separately from the tree information transmitted from the server 100, and based on the imaginary tree information, manages the cache memory 20 on a region basis. Accordingly, the user terminal 200 caches in advance contents (image data) constituted of model and view and removes contents that would be unnecessary from the cache, thereby efficiently executing cache management.

### Modified Example

The present disclosure is not limited to the embodiment described above and may be variously modified without departing from the gist of the present disclosure.

In the embodiment described above, the example in which the display region is changed by an operation of a user is shown, for example. However, even in the case where the operation of the user is not involved, the cache may be changed based on changes of various contexts. For example, in the case where the user terminal 200 includes a GPS (Global Positioning System) sensor, a geomagnetic sensor, and the like and also includes an application for displaying photographs in which a display region is changed based on position information of the user terminal 200, imaginary tree information may be generated based on a change of the position information and contents stored in a cache may be changed. In addition, contents stored in a cache may be changed based on other sensor information such as a change in climate information, a change in situation of other user terminals 200, a change in popularity of contents, and the like.

Further, in the case where the user terminal 200 is capable of executing an image search application, the user terminal 200 may generate imaginary tree information for cache based on a correspondence between keywords with high popularity and image data as search results by the keywords and may store in the cache memory 20 image data having a high possibility of being displayed as search results.

In the embodiment described above, the example in which the user terminal 200 as a client acquires image files from the server 100 is described. However, the function of the user terminal 200 and that of the server 100 are not necessarily executed in the respective apparatuses that are physically distant from each other. In other words, the function of the user terminal 200 and that of the server 100 may be logically allocated within one apparatus.

For example, the function of the user terminal 200 may be provided as a browser, and the function of the server 100 may be provided as a daemon. Operations performed in this apparatus are the same as those in the embodiment described above, except that communication processing between the server 100 and the user terminal 200 via the network is replaced with signal processing between the browser and the daemon within the apparatus.

In the embodiment described above, the present disclosure is applied to the user terminal 200. However, the present disclosure is applicable to an audio player, a television apparatus, a game device, a car navigation apparatus, a recording and reproducing apparatus, and any other information processing apparatuses.

### [Others]

It should be noted that the present disclosure may take the following configurations.

(1) An information processing apparatus, including:

a communication unit configured to receive, from another information processing apparatus, a plurality of image data items that are laid out in an imaginary region having a first area, first tree information indicating a tree structure of the plurality of image data items, and layout information indicating a layout of the plurality of image data items;

a cache memory configured to cache at least a part of the received plurality of image data items;

a display including a display region having a second area that is smaller than the first area, and configured to display a part of the cached plurality of image data items in the display region; and

a controller configured to
divide the imaginary region into a plurality of regions, based on the second area and the received layout information,
   generate second tree information indicating a tree structure of the plurality of image data items, in accordance with the plurality of regions, and
   control the cache memory to cache the at least a part of the plurality of image data items, based on the second tree information.

(2) The information processing apparatus according to Item (1), in which

the controller controls the cache memory to impart points to the plurality of regions, cache in the cache memory an image data item laid out in a region to which points of a predetermined value or more are imparted, and delete from the cache memory an image data item laid out in a region to which points less than the predetermined value are imparted.

(3) The information processing apparatus according to Item (2), in which

in a case where one of the plurality of image data items that is displayed in the display region is changed, the controller regenerates the second tree information based on the changed image data item and recalculates the points to be imparted to the plurality of regions.

(4) The information processing apparatus according to Item (2) or (3), in which

the controller calculates the points to be imparted to the plurality of regions such that the points become higher as a distance between, out of the plurality of regions, a region in which one of the plurality of image data items that is being displayed in the display region is laid out and another region becomes shorter.

(5) The information processing apparatus according to Item (4), in which

the controller imparts extra points, in addition to points corresponding to the distance, to the region in which one of the plurality of image data items that is being displayed in the display region is laid out.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus, comprising:
a communication unit configured to receive, from another information processing apparatus, a plurality of image data items that are laid out in an imaginary region having a first area, first tree information indicating a tree structure of the plurality of image data items, and layout information indicating a layout of the plurality of image data items;
a cache memory configured to cache at least a part of the received plurality of image data items;
a display including a display region having a second area that is smaller than the first area, and configured to display a part of the cached plurality of image data items in the display region; and
a controller configured to
divide the imaginary region into a plurality of regions, based on the second area and the received layout information,
generate second tree information indicating a tree structure of the plurality of image data items, in accordance with the plurality of regions, and
control the cache memory to cache the at least a part of the plurality of image data items, based on the second tree information.

2. The information processing apparatus according to claim 1, wherein
the controller controls the cache memory to impart points to the plurality of regions, cache in the cache memory an image data item laid out in a region to which points of a predetermined value or more are imparted, and delete from the cache memory an image data item laid out in a region to which points less than the predetermined value are imparted.

3. The information processing apparatus according to claim 2, wherein
in a case where one of the plurality of image data items that is displayed in the display region is changed, the controller regenerates the second tree information based on the changed image data item and recalculates the points to be imparted to the plurality of regions.

4. The information processing apparatus according to claim 2, wherein
the controller calculates the points to be imparted to the plurality of regions such that the points become higher as a distance between, out of the plurality of regions, a region in which one of the plurality of image data items that is being displayed in the display region is laid out and another region becomes shorter.

5. The information processing apparatus according to claim 4, wherein
the controller imparts extra points, in addition to points corresponding to the distance, to the region in which one of the plurality of image data items that is being displayed in the display region is laid out.

6. An information processing method, comprising:
receiving, from another information processing apparatus, a plurality of image data items that are laid out in an imaginary region having a first area, first tree information indicating a tree structure of the plurality of image data items, and layout information indicating a layout of the plurality of image data items;
displaying a part of the received plurality of image data items on a display including a display region having a second area that is smaller than the first area;
dividing the imaginary region into a plurality of regions based on the second area and the received layout information and generating second tree information indicating a tree structure of the plurality of image data items in accordance with the plurality of regions; and
caching at least a part of the plurality of image data items, based on the second tree information.

7. A program causing an information processing apparatus to executes the steps of:
receiving, from another information processing apparatus, a plurality of image data items that are laid out in an imaginary region having a first area, first tree information indicating a tree structure of the plurality of image data items, and layout information indicating a layout of the plurality of image data items;
displaying a part of the received plurality of image data items on a display including a display region having a second area that is smaller than the first area;
dividing the imaginary region into a plurality of regions, based on the second area and the received layout information, and generating second tree information indicating a tree structure of the plurality of image data items; and
caching at least a part of the plurality of image data items, based on the second tree information.
